(19) United States
(12) Patent Application Publication
(10) Pub. No.: US 2020/0000191 A1
(43) Pub. Date: Jan. 2, 2020

(54) LUGGAGE SYSTEM

(71) Applicant: Donald Dohmann, Glen Allen, VA (US)

(72) Inventor: Donald Dohmann, Glen Allen, VA (US)

(21) Appl. No.: 16/026,039

(22) Filed: Jul. 2, 2018

(51) Int. Cl. A45C 5/14; F16M 13/00

(52) U.S. Cl. CPC A45C 5/14; A45C 13/262; A45C 2005/148; F16M 13/005

(57) ABSTRACT

An improved luggage system is a piece of wheeled luggage with attached framework having folding legs and a pivoting two-position handle that allows the user to pull the luggage along a floor surface when in a folded position and to rotate the luggage to a horizontal position with the luggage opening facing upward and to allow the user to adjust the luggage to a user preferred height via telescopic legs when in an unfolded position. An accessory bag is attachable to one of the interior surfaces and a lighting system illuminates the interior volume via activation of an on/off switch.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of luggage and more specifically relates to an improved luggage system.

### 2. Description of the Related Art

It is universally common to take extra sets of clothes and other shower type accessories when traveling overnight. The traveler will usually reserve a hotel or motel room for the stay-over and then resume traveling the following day. Sometimes, the traveler will stay with relatives in suitable accommodations but one thing that is always true; the accommodations do not have the comfort that one's own home has. In some hotels, there is a scissor type stand for holding the luggage up off of the floor but many do not have this convenience. Instead, the luggage must be placed on the bed to access the contents, and then returned to the floor or to the stand if the room has one. The traveler is constantly inconvenienced by having to move the luggage from one location to another during the stay. Even if the room has a luggage stand, it is only for one luggage piece and it is seldom tall enough to keep the traveler from having to stoop over to access the contents. This is especially inconvenient when the traveler has back trouble, is elderly, or there is the possibility of the luggage being invaded by bedbugs as can happen at any motel. A solution to eliminate all of these problems is needed.

Ideally, luggage should provide durability and ease of access, and yet would operate reliably and be manufactured at a modest expense. Thus, a need exists for a reliable improved luggage system to avoid the above-mentioned problems.

### BRIEF SUMMARY OF THE INVENTION

In view of the foregoing disadvantages inherent in the known luggage art, the present invention provides a novel improved luggage system. The general purpose of the present invention, which will be described subsequently in greater detail, is to provide an improved luggage system with foldable and telescoping support legs which raise the luggage off the floor to allow a user to access the contents without bending or crouching. It further has additional folding panels for storing extra shoes and the like.

The improved luggage system preferably comprises a base member having a flat bottom panel, a plurality of side members extending from the flat bottom panel that form a substantially rectangular volume, a plurality of wheel members spaced from one another that are attached to one of the plurality of side members that are adapted to allow a person to roll the improved luggage system along a supporting surface, a zipper member attached along a periphery of the plurality of side members, and a top member including a zipper member attached along a periphery of the top member that is adapted to releasably connect with the zipper member of the plurality of side members. The flat bottom panel, the side members, and the top member are preferably formed from a material chosen from a group of materials consisting of nylon, plastic, cotton, and rayon.

The top member is pivotally attached along a length of one of the side members and is adapted to pivot 180 degrees therefrom. An adjustable handle member is pivotally connected at a middle section to one of the side members, and is adapted to pivot 90 degrees such that in a first position the adjustable handle member is substantially parallel to the flat bottom panel and adapted to be used to roll the improved luggage system on a supporting surface. In a second position the adjustable handle member is substantially perpendicular to the flat bottom panel and adapted to be used to support the improved luggage upon the supporting surface.

A pivoting leg member is pivotally connected at a proximal end to one of the side members opposite from the side member. The adjustable handle member is connected to and is adapted to pivot 90 degrees such that in a first position the pivoting leg member is substantially parallel to the flat bottom panel, and such that in a second position the adjustable handle member is substantially perpendicular to the flat bottom panel and adapted to be used to support the improved luggage upon the supporting surface along with the adjustable handle member. A flexible panel member having a plurality of pockets attached thereon, are adapted to contain shoes and personal items therein. The flexible panel member is adapted to be attached to the outer surface of any one of the side members.

A light assembly is connected to the top member that includes a plurality of light bars electrically connected to each other. A power source is electrically connected to the plurality of light bars and a light switch is electrically connected to the plurality of light bars and the power source. The light assembly may be attached to an inside portion of the top member to illuminate the rectangular volume. The power source of the light assembly may be formed as a replaceable battery but in some embodiments may be formed as a rechargeable battery.

The adjustable handle member includes a handle portion on the proximal end that is adapted to be grasped by a user, and a plurality of wheels are attached to the distal end adapted to allow a person to roll the improved luggage system along the supporting surface by pulling the adjustable handle member. The adjustable handle member is adapted to be releasably locked into a first position or into a second position and the pivoting leg member is adapted to be releasably locked into a first position or into a second position. The adjustable handle member includes two spaced telescoping support arms adapted to telescopingly extend outward from the base member and into a locked position. The adjustable handle member is mechanically connected to the pivoting leg member such that when the adjustable handle member is moved between its respective first and second positions, the pivoting leg member also moves between its respective first and second positions. The adjustable handle member and the pivoting leg member are adapted to hold the flat bottom panel of the base member in a substantially parallel position with respect to a supporting surface. The adjustable handle member and the pivoting leg member are preferably formed from a material chosen from the group of materials consisting of steel, aluminum, carbon fiber, and graphite.

The pivoting leg member includes two spaced parallel legs of equal length. The adjustable handle member is mechanically connected to the pivoting leg member via two spaced tie rod members. The two spaced parallel legs of the pivoting leg member are formed as telescoping leg members adapted to be adjustable in length in order to position the improved luggage system at a user preferred height for use. The adjustable handle member is adapted to be locked in its respective first and second positions, and includes a button member thereon adapted to release the adjustable handle member from the respective first and second positions. The pivoting leg member is also adapted to be locked in its respective first and second positions, and includes a button member thereon adapted to release the pivoting leg member from the respective first and second positions.

The present invention holds significant improvements and serves as an improved luggage system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, an improved luggage system, constructed and operative according to the teachings of the present invention.

FIG. 1 shows a perspective view illustrating an improved luggage system in an in-use condition according to an embodiment of the present invention.

FIG. 2 is a second perspective view illustrating improved luggage system in an in-use condition according to an embodiment of the present invention of FIG. 1.

FIG. 3 is a front elevation view illustrating improved luggage system according to an embodiment of the present invention of FIG. 1.

FIG. 4 is a rear elevation view illustrating improved luggage system according to an embodiment of the present invention of FIG. 1.

FIG. 5 is a perspective view illustrating improved luggage system 100 in a partially folded position, according to an embodiment of the present invention of FIG. 1.

FIG. 6 is a left side view illustrating improved luggage system in a folded position, according to an embodiment of the present invention of FIG. 1.

FIG. 7 is a perspective view illustrating the height adjustment and leg release of the improved luggage system according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to luggage and more particularly to an improved luggage system as used to improve the foldable and telescoping support legs which raise the luggage off the floor to allow a user to access the contents without bending or crouching. It further has additional folding panels for storing extra shoes and the like.

Generally speaking, an improved luggage system is a framework attached to a piece of wheeled luggage having folding legs and a pivoting two position handle that allows the user to pull the luggage along a floor surface when in a folded position and to rotate the luggage to a horizontal position with the luggage opening facing upward and to allow the user to adjust the luggage to a user preferred height via telescopic legs when in an unfolded position. An accessory bag is attachable to one of the interior surfaces and a lighting system illuminates the interior volume via an on/off switch.

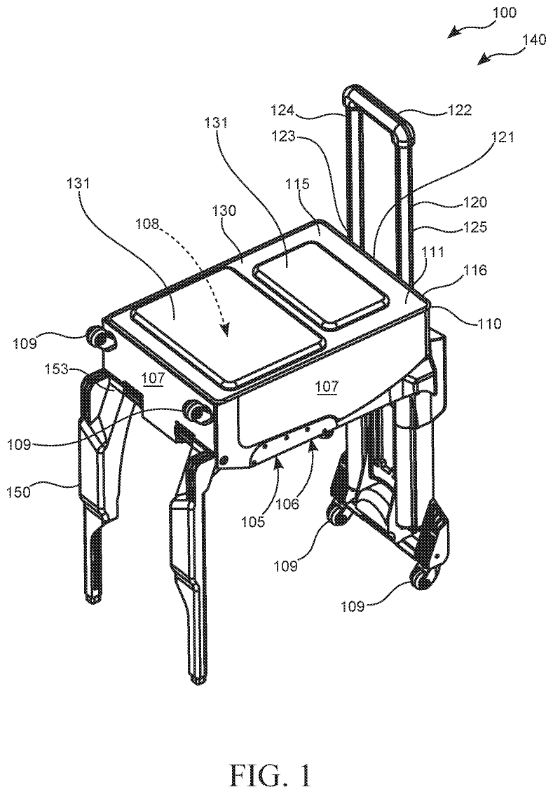

Referring to the drawings by numerals of reference there is shown in FIG. 1 a perspective view illustrating improved luggage system 100 in an in-use condition according to an embodiment of the present invention.

Top member 115 is pivotally attached along a length of one of side members 107 and is adapted to pivot 180 degrees therefrom. Adjustable handle member 120 is pivotally connected at middle section 121 to one of side members 107, and is adapted to pivot 90 degrees such that in first position 140 adjustable handle member 120 is substantially parallel to flat bottom panel 106 and adapted to be used to roll improved luggage system 100 on a supporting surface. In second position 145 adjustable handle member 120 is substantially perpendicular to flat bottom panel 106 and adapted to be used to support improved luggage system 100 upon a supporting surface.

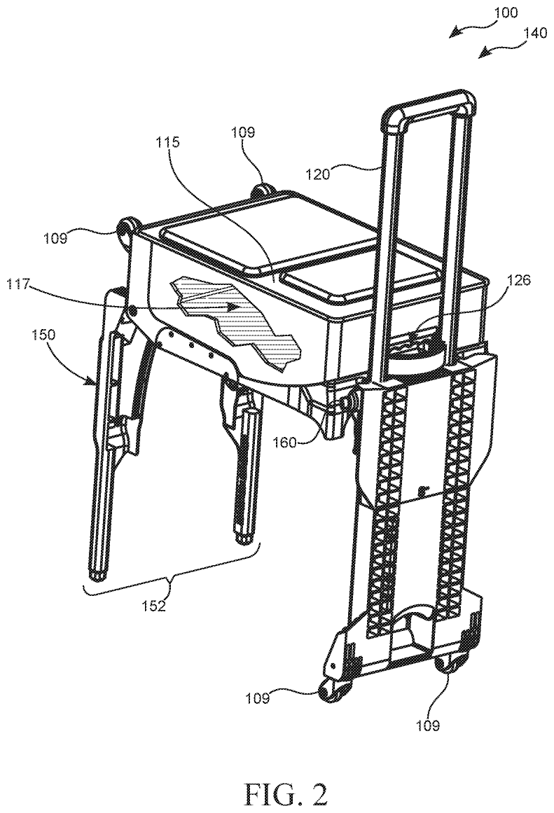

FIG. 2 is a second perspective view illustrating improved luggage system 100 in the in-use condition according to an embodiment of the present invention of FIG. 1.

Pivoting leg member 150 includes two spaced parallel leg(s) 152 of equal length. Adjustable handle member 120 is mechanically connected to pivoting leg member 150 via two spaced tie rod members 160. The two spaced parallel leg(s) 152 of pivoting leg member 150 are formed as telescoping leg members 152 adapted to be adjustable in length in order to position improved luggage system 100 at a user preferred height for use. When telescoping leg members 152 are extended, it is only intended when in the position shown in FIG. 2 so that the height of improved luggage system 100 with the opening or top member 115 oriented upward to prevent a user from having to stoop too far when in use.

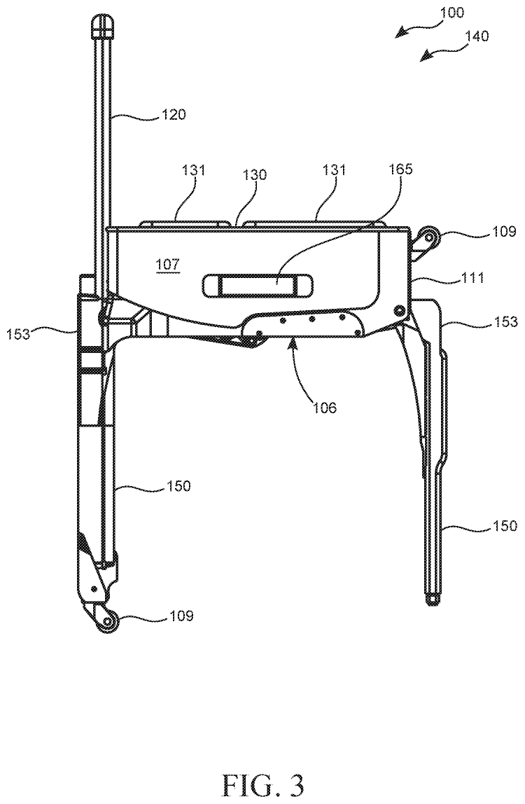

FIG. 3 is a front elevation view illustrating improved luggage system 100 according to an embodiment of the present invention of FIG. 1.

Pivoting leg member 150 is pivotally connected at proximal end 153 to one of side members 107. Opposite from this side member 107 adjustable handle member 120 is connected to and is adapted to pivot 90 degrees such that in first position 140 pivoting leg member 150 is substantially parallel to flat bottom panel 106, and such that in second position 145 adjustable handle member 120 is substantially perpendicular to flat bottom panel 106 and adapted to be used to support improved luggage system 100 upon the supporting surface. Flexible panel member 130 having a plurality of pockets 131 attached thereon, are adapted to contain shoes and personal items therein. Flexible panel member 130 is adapted to be attached to outer surface 111 of any one of side members 107. As seen in this figure, the carry handle 165 is oriented toward the side while in an in-use condition or first position 140, but becomes oriented toward the top when folded and hand carried, or it is rotated 90 degrees with carry handle 165 still on side member 107 when being pulled using wheel members 109 to support the weight.

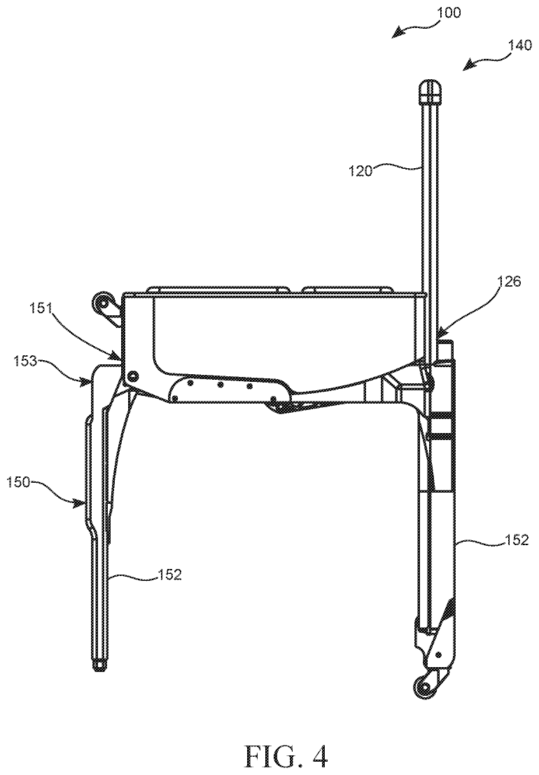

FIG. 4 is a rear elevation view illustrating improved luggage system 100 according to an embodiment of the present invention of FIG. 1.

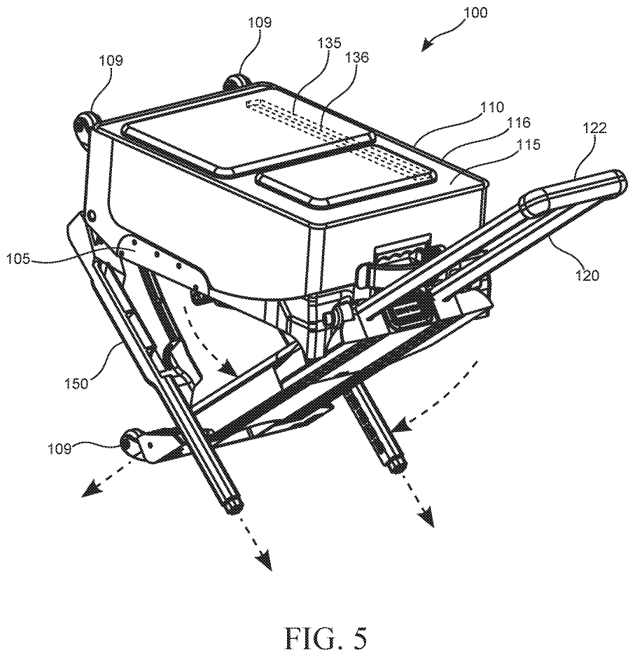

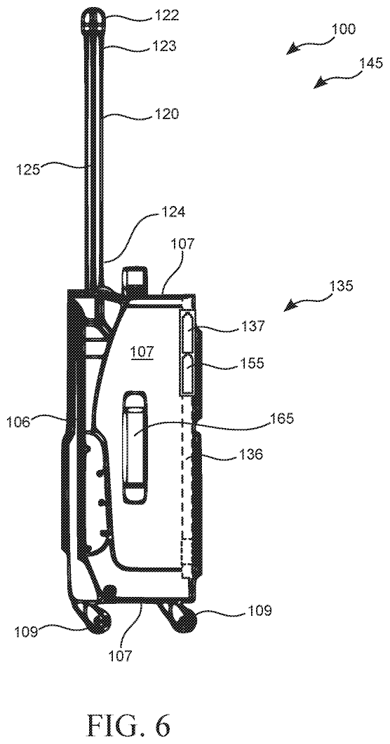

Adjustable handle member 120 is adapted to be locked in its respective first 140 and second position 145, and includes button member 126 thereon adapted to release adjustable handle member 120 from the respective first 140 and second positions 145. Pivoting leg member 150 is also adapted to be locked in its respective first 140 and second positions 145, and includes button member 151 thereon adapted to release pivoting leg member 150 from the respective first 140 and second positions 145. First position 140 is when unfolded and locked into the position shown in FIG. 4 and second position 145 is when folded and locked into the position shown in FIGS. 5 and 6.

FIG. 5 is a perspective view illustrating improved luggage system 100 in a partially folded position, according to an embodiment of the present invention of FIG. 1.

In this view, arrows demonstrate the adjustments and the directions of movement during folding and height adjustment. Adjustable handle member 120 and pivoting leg member 150 not only pivot between first position 140 and second position 145, or an unfolded and a folded position, but extend and retract in length so that in the unfolded or first position 140, the user may adjust the height of improved luggage system 100 off of the floor so that the contents can be accessed without having to placed it on a piece of furniture such as a bed, dresser, or table, to prevent bending or kneeling down and then having to move it again when finished. Some motels supply a stand for placing luggage on but generally the stands are too short for the majority of users unless sitting. Adjustable handle member 120 and pivoting leg member 150 components are preferably constructed of a lightweight material but designed to withstand torsional stresses when in first position 140 and in second position 145 or transporting position so as to remain sturdy during use. Adjustable handle member 120 and pivoting leg member 150 are preferably formed from a material chosen from the group of materials consisting of steel, aluminum, carbon fiber, and graphite.

FIG. 6 is a left side view illustrating improved luggage system 100 in a folded position, according to an embodiment of the present invention of FIG. 1.

Light assembly 135 is connected to top member 115 that may include a plurality of light bars 136 electrically connected to each other. Power source 137 is electrically connected to the plurality of light bars 136 and light switch 138 is electrically connected to the plurality of light bars 136 and power source 137. Light assembly 135 may be attached to an inside portion of top member 115 to illuminate the rectangular volume. Power source 137 of light assembly 135 may be formed as replaceable battery 155 but in some embodiments may be formed as a rechargeable battery. Light bars 136 are elongated and in this view are shown so that the length of light bars 136 is seen inside improved luggage system 100 and depicted in dotted lines. Light switch 138 is also shown in dotted lines attached to light bars 136.

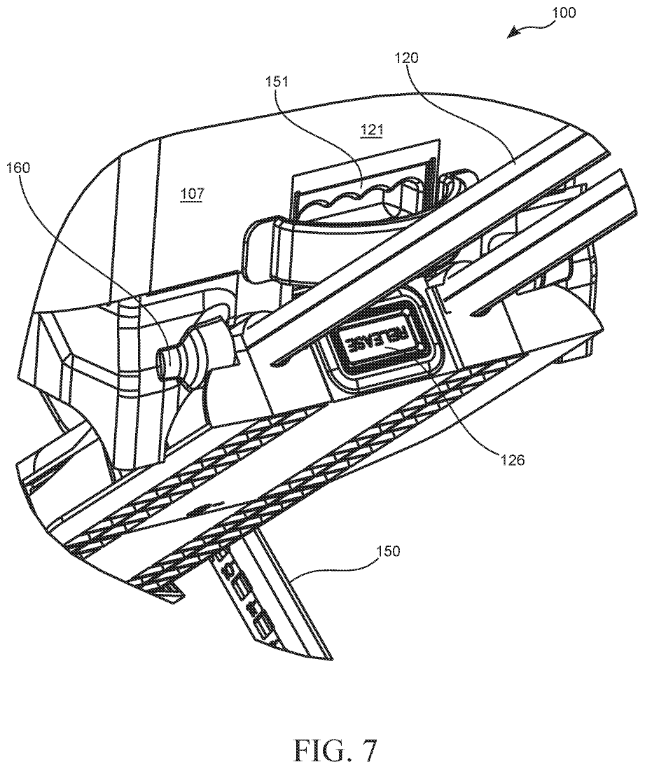

FIG. 7 is a perspective view illustrating the height adjustment and leg release of improved luggage system 100 according to an embodiment of the present invention of FIG. 1.

Adjustable handle member 120 includes handle portion 122 on proximal end 123 that is adapted to be grasped by a user, and a plurality of wheel members 109 are attached to distal end 124 adapted to allow a person to roll improved luggage system 100 along the supporting surface by pulling adjustable handle member 120. Adjustable handle member 120 is adapted to be releasably locked into first position 140 or into second position 145 and pivoting leg member 150 is adapted to be releasably locked into first position 140 or into second position 145. Adjustable handle member 120 includes two spaced telescoping support arms 125 adapted to telescopingly extend outward from base member 105 and into a locked position.

Adjustable handle member 120 is mechanically connected to pivoting leg member 150 such that when adjustable handle member 120 is moved between its respective first position 140 and second position 145, pivoting leg member 150 also moves between its respective first position 140 and second position 145. Adjustable handle member 120 and pivoting leg member 150 are adapted to hold flat bottom panel 106 of base member 105 in a substantially parallel position with respect to a supporting surface.

Improved luggage system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. An improved luggage system comprising:
a base member including:
a flat bottom panel;
a plurality of side members;
wherein said plurality of side members extend from said flat bottom panel and form a substantially rectangular volume;
a plurality of wheel members;
wherein said plurality of wheel members are spaced from one another and attached to one of said plurality of side members and adapted to allow a person to roll said improved luggage system along a supporting surface; and
a zipper member;
wherein said zipper member is attached along a periphery of said plurality of side members;
a top member including:
a zipper member;
wherein said zipper member is attached along a periphery of said top member and is adapted to releasably connect with said zipper member of said plurality of side members;
wherein said top member is pivotally attached along a length of one of said plurality of side members and is adapted to pivot 180 degrees therefrom;
an adjustable handle member;
wherein said adjustable handle member is pivotally connected at a middle section thereof to one of said plurality of side members, and is adapted to pivot 90 degrees therefrom, such that in a first position said adjustable handle member is substantially parallel to said flat bottom panel and adapted to be used to roll said improved luggage system on said supporting surface, and such that in a second position said adjustable handle member is substantially perpendicular to said flat bottom panel and adapted to be used to support said improved luggage upon said supporting surface; and
a pivoting leg member;
wherein said pivoting leg member is pivotally connected at a proximal end thereof to an one of said plurality of side members opposite from said side member said adjustable handle member is connected to, and is adapted to pivot 90 degrees therefrom, such that in a first position said pivoting leg member is substantially parallel to said flat bottom panel, and such that in a second position said adjustable handle member is substantially perpendicular to said flat bottom panel and adapted to be used to support said improved luggage upon said supporting surface along with said adjustable handle member.

2. The improved luggage system of claim 1, further comprising:
a flexible panel member including:
a plurality of pockets attached thereon and adapted to contain shoes and personal items therein;
wherein said flexible panel member is adapted to be attached to an outer surface of any one of said plurality of side members; and
a light assembly connected to said top member including;
a plurality of light bars electrically connected to each other;
a power source electrically connected to said plurality of light bars; and
a light switch electrically connected to said plurality of light bars and said power source.

3. The improved luggage system of claim 1, wherein said adjustable handle member includes a handle portion on a proximal end thereof adapted to be grasped by a user; and a plurality of wheels attached to a distal end thereof adapted to allow a person to roll said improved luggage system along said supporting surface.

4. The improved luggage system of claim 1, wherein said adjustable handle member is adapted to be releasably locked into its said first position, and releasably locked into its said second position.

5. The improved luggage system of claim 4, wherein said pivoting leg member is adapted to be releasably locked into its said first position, and releasably locked into its said second position.

6. The improved luggage system of claim 1, wherein said adjustable handle member includes two spaced telescoping support arms adapted to telescopingly extend outward from said base member and into a locked position.

7. The improved luggage system of claim 1, wherein said adjustable handle member is mechanically connected to said pivoting leg member, such that when said adjustable handle member is moved between its respective said first and second positions said pivoting leg member also moves between its respective said first and second positions.

8. The improved luggage system of claim 1, wherein said adjustable handle member and said pivoting leg member are adapted to hold said flat bottom panel of said base member in a substantially parallel position with respect to said supporting surface.

9. The improved luggage system of claim 1, wherein said adjustable handle member and said pivoting leg member are formed from material chosen from a group of materials consisting of steel, aluminum, carbon fiber, and graphite.

10. The improved luggage system of claim 2, wherein said light assembly is attached to an inside portion of said top member to illuminate said rectangular volume.

11. The improved luggage system of claim 2, wherein said power source of said light assembly is formed as a replaceable battery.

12. The improved luggage system of claim 1, wherein said flat bottom panel, said plurality of side members, and said top member are formed from a material chosen from a group of materials consisting of nylon, plastic, cotton, and rayon.

13. The improved luggage system of claim 1, wherein said pivoting leg member includes two spaced parallel legs of equal length.

14. The improved luggage system of claim 7, wherein said adjustable handle member is mechanically connected to said pivoting leg member via two spaced tie rod members.

15. The improved luggage system of claim 13, wherein said two spaced parallel legs of said pivoting leg member are formed as telescoping leg members adapted to be adjustable in length.

16. The improved luggage system of claim 1, wherein said adjustable handle member is adapted to be locked in its respective first and second positions, and includes a button member thereon adapted to release said adjustable handle member from said respective first and second positions; and wherein said pivoting leg member is adapted to be locked in its respective first and second positions, and includes a button member thereon adapted to release said pivoting leg member from said respective first and second positions.
